(19) United States
(12) Patent Application Publication
(10) Pub. No.: US 2025/0300566 A1
(43) Pub. Date: Sep. 25, 2025

(54) APPARATUS AND METHOD FOR CONTROLLING A TWO-STAGE BIDIRECTIONAL AC-DC POWER CONVERTER

(71) Applicant: Huawei Digital Power Technologies Co., Ltd., Shenzhen (CN)

(72) Inventors: Muhammad YAQOOB, Kista (SE); Grover Victor Torrico-Bascope, Kista (SE)

(73) Assignee: Huawei Digital Power Technologies Co., Ltd., Shenzhen (CN)

(21) Appl. No.: 19/230,628

(22) Filed: Jun. 6, 2025

Related U.S. Application Data
(63) Continuation of application No. PCT/EP2022/085179, filed on Dec. 9, 2022.

(51) Int. Cl. H02M 3/335; H02M 1/00; H02M 1/14

(52) U.S. Cl. CPC H02M 3/33584; H02M 1/007; H02M 1/14

(57) ABSTRACT

A two-stage bi-directional AC-DC power converter with a controller has a main control loop and an auxiliary control loop. The main control loop regulates the output of the DC-DC converter stage. The auxiliary control loop receives a converter signal that includes information about ripple induced on the external DC power by the AC-DC converter stage. The converter signal is bandpass filtered to isolate the ripple information and loop compensation is applied to the filtered signal. The compensated signal is bandpass filtered again to generate a ripple control signal. In inverter mode the ripple control signal is subtracted from the main control signal to reduce a loop gain of the main control loop only at the ripple frequency. In rectifier mode, the ripple control signal is added to the main control signal to increase a loop gain of the main control loop only at the ripple frequency.

### CROSS-REFERENCE TO RELATED APPLICATIONS

This application is a continuation of International Application No. PCT/EP2022/085179, filed on Dec. 19, 2022, the disclosure of which is hereby incorporated by reference in its entirety.

### TECHNICAL FIELD

The embodiments generally relate to a power conversion apparatus and to control methodologies for switching power converters.

### BACKGROUND

Bi-directional AC-DC power converters are often constructed by coupling multiple converter stages together. For example, an AC-DC switching converter stage may be coupled with a regulated DC-DC switching converter stage to form a two-stage bi-directional AC-DC power converter. Employing bi-directional converter topologies in each stage allows the two stage AC-DC power converter to be operated as either an inverter or a rectifier.

Generally, it is important to avoid imposing ripple on the DC power side of the converter. Ripple can be harmful to batteries or other DC power apparatus connected to the DC side of the power converter. Ripple typically occurs at twice the line frequency of the AC power and shows up as either a voltage or current ripple on the DC side of the converter.

Some conventional solutions reduce ripple by increasing capacitance on the DC bus. This reduces power density of the converter and limits dynamic performance. Other solutions are designed to operate in one direction only, i.e., in either inverter mode or rectifier mode but not both. Complex control strategies are available but are difficult to implement and increase the component count.

Thus, there is a need for improved apparatus and methods capable of controlling bi-directional power flow in a two-stage AC-DC power converter using a single simplified control scheme having a reduced component count and presenting reduced ripple at the DC power source. Accordingly, it would be desirable to provide methods and apparatus that address at least some of the problems described above.

### SUMMARY

The embodiments are directed to apparatus and methods for controlling a two-stage bi-directional AC-DC power converter. The embodiments control both rectifier and inverter power flows in the two-stage bi-directional AC-DC power converter using a single simplified control scheme having a reduced component count and presenting reduced ripple at the DC power source.

According to a first aspect, the above and further implementations and advantages are obtained by an apparatus. The apparatus includes a bi-directional AC-DC switching converter stage configured to transfer power between an external AC power and a DC bus power; a bi-directional DC-DC switching converter stage configured to receive a converter control signal (x_{c}) and transfer power between the DC bus power and an external DC power, where the power is transferred in accordance with the converter control signal (x_{c}); and a controller, where the controller includes a main controller and an auxiliary controller. The main controller is configured to receive a first converter signal (s₁) and a reference signal (V_{ref}), generate a converter error signal (e_{c}) based on the first converter signal (s₁) and the reference signal (V_{ref}), and generate a main control signal (xₘ) by applying a main compensation to the converter error signal (e_{c}). The auxiliary controller includes: a first band pass filter configured to extract a ripple signal (r) based on a second converter signal (s₂); an auxiliary compensation configured to generate a ripple control signal (xᵣ) by applying the auxiliary compensation to the ripple signal (r); and a second bandpass filter configured to generate an auxiliary control signal (xₐ) based on the ripple control signal (xᵣ). The controller is configured to generate the converter control signal (x_{c}) by combining the main control signal (xₘ) and the auxiliary control signal (xₐ).

In a possible implementation form, the first converter signal (s₁) and the second converter signal (s₂) include one or more of a voltage of the DC bus (V_{bus}), a voltage of the external DC power (V_{DC}), and a current of the external DC power (I_{DC}). The described signals allow bi-directional power flow to be controlled with a single control scheme that is independent of the converter topology of the bi-directional DC-DC switching converter stage.

In a possible implementation form, the first bandpass filter and the second band pass filter are configured to attenuate frequencies above and below a ripple frequency (fᵣ), where the ripple frequency (fᵣ) is two times a line frequency (f_{L}) of the external AC power. Limiting the frequencies included in the auxiliary control signal allows the auxiliary control signal to be used to modified the loop gain of the main controller only at the ripple frequency, thereby avoiding any reduction in transient or dynamic behavior of the main control loop.

In a possible implementation form, one or more of the main compensation and the auxiliary compensation include a proportional plus integral (PI) compensation algorithm. PI controllers provide a well understood and stable controller design that is simple to implement and analyze.

In a possible implementation form, the main compensation and the auxiliary compensation include the same control algorithm. Use of the same control algorithm in both the main and auxiliary controllers simplifies tuning of the system.

In a possible implementation form, the first bandpass filter includes a first plurality of band pass filters and the output produced by each bandpass filter in the first plurality of bandpass filters is summed together to produce the ripple signal (r). A center frequency of each bandpass filter in the first plurality of band pass filters is an integer multiple of two times the line frequency (n*2f_{L}). The second bandpass filter includes a second plurality of band pass filters and the output produced by each bandpass filter in the second plurality of bandpass filters is summed together to produce the auxiliary control signal (xₐ). A center frequency of each bandpass filter in the second plurality of bandpass filters is the same as the center frequency of a corresponding one bandpass filter in the first plurality of bandpass filters. Use of multiple harmonics when generating the ripple signal and the auxiliary control signal provides improved ripple reduction when driving non-linear AC loads.

In a possible implementation form, the apparatus is operated as an inverter, the first converter signal is the voltage of the DC bus (V_{bus}), the second converter signal (s₂) is the current of the external DC power (I_{DC}); and the main controller is configured to subtract the auxiliary control signal (xₐ) from the main control signal (xₘ). Use of the current of the external DC power provides ripple information to the controller and subtracting the auxiliary control signal from the main control signal reduces the loop gain of the main control loop only at the ripple frequency.

In a possible implementation form, the apparatus is operated as a rectifier, the first converter signal (s₁) is the voltage of the external DC power (V_{DC}), the second converter signal (s₂) is the voltage of the external DC power (V_{DC}), and the main controller is configured to add the auxiliary control signal (xₐ) to the main control signal (xₘ). When operating as a rectifier the voltage of the external DC power provides suitable ripple information to the auxiliary controller, and adding the auxiliary control signal to the main control signal increases the loop gain of the main control loop only at the ripple frequency.

According to a second aspect, the above and further implementations and advantages are obtained by a method. The method is configured to control a power converter, where the power converter includes a bi-directional AC-DC switching converter stage configured to transfer power between an external AC power and a DC bus power, and a bi-directional DC-DC switching converter stage configured to receive a converter control signal (x_{c}) and transfer power between the DC bus power and an external DC power in accordance with the converter control signal (x_{c}). The method includes generating a converter error signal (e_{c}) by comparing a first converter signal (s₁) with a reference signal (V_{ref}) and generating a main control signal (xₘ) by applying a main control algorithm to the converter error signal (e_{c}). The method generates a ripple signal (r) by bandpass filtering a second converter signal (s₂), generates a ripple control signal (xᵣ) by applying an auxiliary control algorithm to the ripple signal (r), and generates an auxiliary control signal (xₐ) by bandpass filtering the ripple control signal (xᵣ). The method generates the converter control signal (x_{c}) by combining the main control signal (xₘ) with the auxiliary control signal (xₐ).

In a possible implementation form, the first converter signal (s₁) and the second converter signal (s₂) include one or more of a voltage of the DC bus (V_{bus}), a voltage of the external DC power (V_{DC}), and a current of the external DC power (I_{DC}). The selected signals allow bi-directional power flow to be controlled with a single control scheme that is independent of the converter topology used in the bi-directional DC-DC switching converter stage.

In a possible implementation form, the bandpass filtering includes attenuating frequencies above and below a ripple frequency (fᵣ), where the ripple frequency (fᵣ) is two times a line frequency (f_{L}) of the external AC power. Limiting the frequencies included in the auxiliary control signal allows the auxiliary control signal to be used to modified the loop gain of the main controller only at the ripple frequency, thereby avoiding any change in transient or dynamic behavior of the main control loop.

In a possible implementation form, the bandpass filtering includes attenuating frequencies greater than or less than a pre-determined range of frequencies, where the pre-determined range of frequencies is centered about the ripple frequency (fᵣ). Use of a range of frequencies avoids distortion of the ripple signal that could occur when a narrow pass band is used.

In a possible implementation form, one or more of the main control algorithm and the auxiliary control algorithm include a proportional plus integral (PI) control algorithm. PI controllers provide a well understood and stable controller design that is simple to implement and analyze.

In a possible implementation form, the main control algorithm and the auxiliary control algorithm include the same control algorithm. Use of the same control algorithm in both the main and auxiliary controllers simplifies tuning of the system.

These and other aspects, implementation forms, and advantages of the embodiments will become apparent from the embodiments described herein considered in conjunction with the accompanying drawings. It is to be understood, however, that the description and drawings are designed solely for purposes of illustration and not for limiting the embodiments. Additional aspects and advantages of the embodiments will be set forth in the description that follows, and in part will be clear from the description or may be understood by practice of the embodiments. Moreover, the aspects and advantages of the embodiments may be realized and obtained by the instrumentalities and combinations particularly pointed out herein.

### BRIEF DESCRIPTION OF THE DRAWINGS

In the following, the embodiments will be explained in more detail with reference to the drawings, in which like references indicate like elements.

FIG. 1 illustrates a block diagram of an exemplary two-stage bidirectional AC-DC power converter incorporating aspects of the embodiments;

FIG. 2 illustrates an exemplary controller configured to regulate inverter operation of a two-stage bidirectional AC-DC switching power converter incorporating aspects of the embodiments;

FIG. 3 illustrates an exemplary controller configured to regulate rectifier operation of a two-stage bidirectional AC-DC switching power converter incorporating aspects of the embodiments;

FIG. 4 illustrates an exemplary controller configured to reduce ripple in power converters experiencing nonlinear load behavior incorporating aspects of the embodiments; and

FIG. 5 illustrates a flow chart of an exemplary method for controlling a two-stage bi-directional AC-DC power converter incorporating aspects of the embodiments.

### DETAILED DESCRIPTION OF EMBODIMENTS

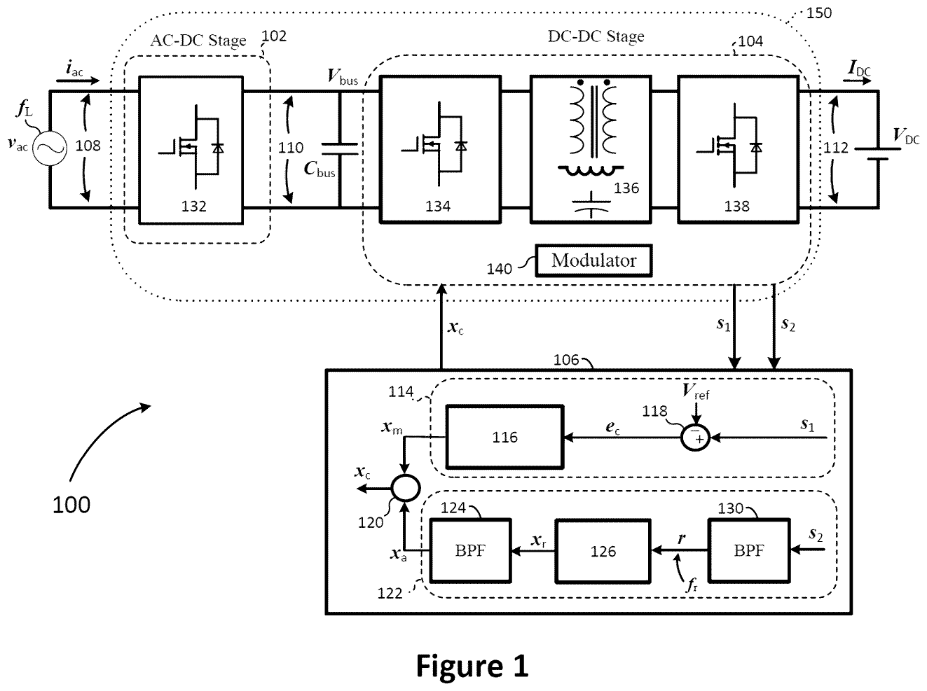

FIG. 1 illustrates a block diagram of an exemplary power conversion apparatus 100 incorporating aspects of the embodiments. The aspects of the embodiments control both rectifier and inverter power flows in the two-stage bi-directional AC-DC power converter using a single simplified control scheme having a reduced component count and presenting reduced ripple at the DC power source.

As is shown in the example of FIG. 1, the apparatus 100 includes a bi-directional AC-DC switching converter stage 102. The converter stage 102 is configured to transfer power between an external AC power 108 and a DC bus power 110. A bi-directional DC-DC switching converter stage 104 is configured to receive a converter control signal (xc) and transfer power between the DC bus power 110 and an external DC power 112 in accordance with the converter control signal (xc).

The apparatus 100 further includes a controller 106. The controller 106 includes main controller 114 and an auxiliary controller 122. The main controller 114 is configured to receive a first converter signal (s1) and a reference signal (Vref); generate a converter error signal (ec) based on the first converter signal (s1) and the reference signal (Vref); and generate a main control signal (xm) by applying a main compensation (116) to the converter error signal (ec).

In one embodiment, as shown in FIG. 1, the auxiliary controller 122 includes a first band pass filter 130 configured to generate a ripple signal (r) based on a second converter signal (s2). The auxiliary controller 122 also includes an auxiliary compensation 126 configured to generate a ripple control signal (xr) by applying the auxiliary compensation 126 to the ripple signal (r). A second bandpass filter 124 is configured to generate an auxiliary control signal (xa) based on the ripple control signal (xr). The controller 106 is configured to generate the converter control signal (xc) by combining the main control signal (xm) and the auxiliary control signal (xa).

In one embodiment, the two-stage bi-directional AC-DC switching power converter 150 of the apparatus 100 is operated by the improved controller 106. The controller 106 is configured to regulate an output of the converter 150 while reducing ripple imparted on the DC power 112. These improvements and advantages are obtained in part by employing an improved controller 106 that incorporates the main controller 114 and the auxiliary controller 122 to provide a simplified control scheme that is capable of controlling bi-directional power flow while reducing ripple on the external DC power 112 and reducing the overall component count.

In the exemplary apparatus 100, the two-stage bidirectional AC-DC switching power converter 150 includes a bi-directional AC-DC switching converter stage 102, also referred to herein as an AC-DC converter stage 102, coupled between an external AC power 108 and a DC bus power 110, and a bi-directional DC-DC switching converter stage 104, also referred to herein as a DC-DC converter stage 104, coupled between the DC bus power 110 and an external DC power 112. The DC-DC converter stage 104 receives a converter control signal x_{c} from the controller 106, and is adapted to regulate power flowing between the DC bus power 110 and the external DC power 112, where the power is regulated based on a converter control signal x_{c}. When desired, the DC-DC converter stage may be configured to maintain a substantially linear relationship between power flowing through the DC-DC converter stage 104 and a magnitude of the converter control signal x_{c}.

The external AC power 108 may be any suitable AC power, such as the European grid power having a fifty hertz (50 Hz) line frequency f_{L}, the North American grid power having a sixty hertz (60 Hz) line frequency f_{L}, or other AC power source having any suitable line frequency f_{L} and voltage v_{ac} as desired.

As used herein, the term ripple refers to an unwanted AC component superimposed on a DC signal. Ripple has a primary frequency component fᵣ equal to twice the line frequency f_{L} of the external AC power 108. Ripple may be either a ripple current riding on the DC power such as when the two-stage bi-directional AC-DC switching power converter 150 is operating as an inverter, or a ripple voltage such as when the two-stage bi-directional AC-DC switching power converter 150 is operating as a rectifier. Ripple may also appear on other signals such as signals within the controller 106.

Any appropriate bi-directional AC-DC converter topology capable of bi-directional power transfer between the external AC power 108 and the DC bus power 110 may be advantageously employed as the bi-directional AC-DC switching converter stage 102. For example, in the illustrated apparatus 100, a switching network 132 is incorporated into the bi-directional AC-DC switching converter stage 102 configured to operate as either an inverter or a rectifier to transfer electric energy between the external AC power 108 and the DC bus power 110. In certain embodiments, semiconductor switching devices, such as metal oxide semiconductor field effect transistors (MOSFET), bi-polar junction transistors (BJT), diodes or other appropriate types of semiconductor switching devices, are employed to control the flow of power within the bi-directional AC-DC switching converter stage 102.

Any appropriate bi-directional DC-DC converter topology capable of bi-directional power transfer between the DC bus power 110 and the external DC power 112 may be advantageously employed as the bi-directional DC-DC switching converter stage 104. For example, in the illustrated apparatus 100, the DC-DC converter stage 104 includes a first switching network 134 and a second switching network 138 coupled together through an energy storage network 136. The first switching network 134 is configured to transfer electrical energy between the DC bus power 110 and the energy storage network 136, and the second switching network 138 is configured to transfer electrical energy between the energy storage network 136 and the external DC power 112.

The first and second switching networks 134, 138 may include any appropriate arrangement of switching devices configured to transfer electrical energy to and from the energy storage network 136. The energy storage network 136 may include any suitable arrangement of energy storage devices, such as inductors and capacitors, configured to support power conversion between the DC bus power 110 and the external DC power 112. In certain embodiments, the energy storage network 136 may include a transformer that, when desired, may be configured to provide electrical isolation between the DC bus power 110 and the external DC power 112.

A modulator 140 is included in the DC-DC converter stage 104, where the modulator 140 is configured to receive a converter control signal x_{c} and operate the first switching network 134 and the second switching network 138 to transfer power between the DC bus power 110 and the external DC power 112 in accordance with the received converter control signal x_{c}. The modulator 140 operates the switching networks 134, 138 to provide a power flow corresponding to the converter control signal x_{c}, thereby allowing power flow through the two-stage bi-directional AC-DC power converter 150 to be regulated by the controller 106.

Power flow through the two-stage bidirectional AC-DC switching power converter 150, and for example, power flowing through the DC-DC converter stage 104, is regulated by a controller 106, where the controller 106 is configured to receive one or more converter signals s₁, s₂ and produce the converter control signal x_{c}. The two-stage bidirectional AC-DC switching power converter 150 is capable of transferring power in either direction between the external AC power 108 and the external DC power 112. When operated as an inverter the two-stage bidirectional AC-DC switching power converter transfers electric power from the external DC power 112 to the external AC power 108, and when operated as a rectifier the two-stage bidirectional AC-DC switching power converter 150 transfers electric power from the external AC power 108 to the external DC power.

The controller 106 includes a main controller 114 and an auxiliary controller 122. The main controller 114 is configured to receive the first converter signal s₁ and produce a main control signal xₘ where the main control signal xₘ is adapted to drive an output of the DC-DC converter stage 104 toward a desired output value. The auxiliary controller 122 is configured to receive the second converter signal s₂ and produce an auxiliary control signal xₐ, where the auxiliary control signal xₐ is configured to reduce ripple at the external DC power 112.

A first converter signal s₁, representing the actual output of the DC-DC converter stage 104, and a reference signal V_{ref}, representing a desired output of the DC-DC converter stage 104, are received by the main controller 114. A converter error signal e_{c} is generated by the main controller 114 based on the first converter signal s₁ and the reference signal V_{ref}. When desired the error signal e_{c} may be generated by subtracting 118 the first converter signal s₁ from the reference signal V_{ref} to generate a converter error signal e_{c}, where the converter error signal e_{c} represents the error or difference between the actual converter output and the desired converter output.

A main control signal xₘ is generated by applying a main compensation 116, also referred to as a main control algorithm 116, to the converter error signal e_{c}. As will be discussed further below, the main compensation 116 may include any suitable control algorithm, such as a proportional plus integral (PI) type control algorithm, a gain adjusted PI control algorithm, a proportional plus integral plus derivative (PID) control algorithm, or other appropriate control algorithm.

The main control signal xₘ is adapted by the main controller 114 to minimize the converter error signal e_{c}, thereby maintaining the actual converter output at or near a desired output value as indicated by the reference signal V_{ref}. Unfortunately, the external AC power 108 can induce ripple on the external DC power 112, where the ripple frequency fᵣ is substantially twice the line frequency f_{L} of the external AC power 108.

Certain conventional controllers seek to reduce this ripple by including a larger bus capacitor C_{bus} or by reducing the main controller's bandwidth. Increasing the bus capacitor C_{bus} increases cost and reduces power density of the converter. Use of a large bus capacitor also reduces bandwidth of the main control loop, resulting in slow dynamic response of the DC bus voltage V_{bus} to changes in the external AC power 108. To avoid these drawbacks, an auxiliary controller 122, configured to reduce ripple, is included in the exemplary controller 106.

As will be described in more detail below, the auxiliary controller generates an auxiliary control signal xₐ that is adapted to minimize ripple on the external DC power 112. The auxiliary control signal xₐ is combined with the main control signal xₘ to modify a loop gain of the main controller 114 only around the ripple frequency fᵣ.

The auxiliary controller 122 receives a second converter signal s₂, where the second converter signal s₂ includes information about ripple on the external DC power 112. Examples of converter signals appropriate for use as the second converter signal s₂ include the current I_{DC} of the external DC power 112 and the voltage V_{DC} of the external DC power 112.

Within the auxiliary controller 122, a first band pass filter 130 receives the second converter signal s₂ and generates a ripple signal r based on the second converter signal s₂. The first bandpass filter 130 is configured to pass the primary ripple frequency fᵣ and attenuate frequencies above and below the ripple frequency fᵣ, thereby generating a ripple signal r corresponding to the primary frequency component of the ripple appearing on the external DC power 112.

As used herein, the term bandpass filter refers to a system component that attenuates frequency components of a signal that lie outside a desired frequency range and passes, without significant attenuation, frequency components within the desired frequency range. The frequency range passed without significant attenuation is referred to herein as the pass band. Frequencies above and below the pass band are attenuated and effectively removed from the filtered signal. A bandpass filter may be described as having a center frequency where the center frequency is a frequency of interest lying at or near the center of the pass band of a bandpass filter.

A bandpass filter may be implemented using analog circuitry configured to operate on analog signals. Alternatively, a bandpass filter may be implemented using digital filtering techniques or implemented entirely within software executed by a processor and configured to operate on digitized signals.

A ripple control signal xᵣ is generated by applying an auxiliary compensation 126 to the ripple signal r. In certain embodiments, the auxiliary compensation 126 may add unwanted frequency components to the ripple control signal xᵣ. For example, the integral term in a PI control algorithm can add DC or low frequency components that may not be beneficial if included in the auxiliary control signal xₐ. A second bandpass filter 124 is included in the auxiliary controller 122 to remove unwanted frequency components from the ripple control signal xᵣ and produce a final auxiliary control signal xₐ. When desired the first bandpass filter 130 may be configured to have a similar or the same center frequency and pass band as the second bandpass filter 124. Alternatively, the first bandpass filter 130 and the second bandpass filter 124 may be configured to have different pass bands.

The converter control signal x_{c} is generated by the controller 106 based on the main control signal xₘ and the auxiliary control signal xₐ. In one embodiment, such as when the converter is operating as an inverter, the auxiliary control signal xₐ is subtracted from the main control signal xₘ. Alternatively, the auxiliary control signal xₐ is added to the main control signal xₘ, such as when the converter is operating as a rectifier.

The converter control signal x_{c} is then be applied to the DC-DC converter stage 104 where the modulator 140 will regulate power flow through the two-stage bidirectional AC-DC switching power converter 150 in accordance with the converter control signal x_{c}.

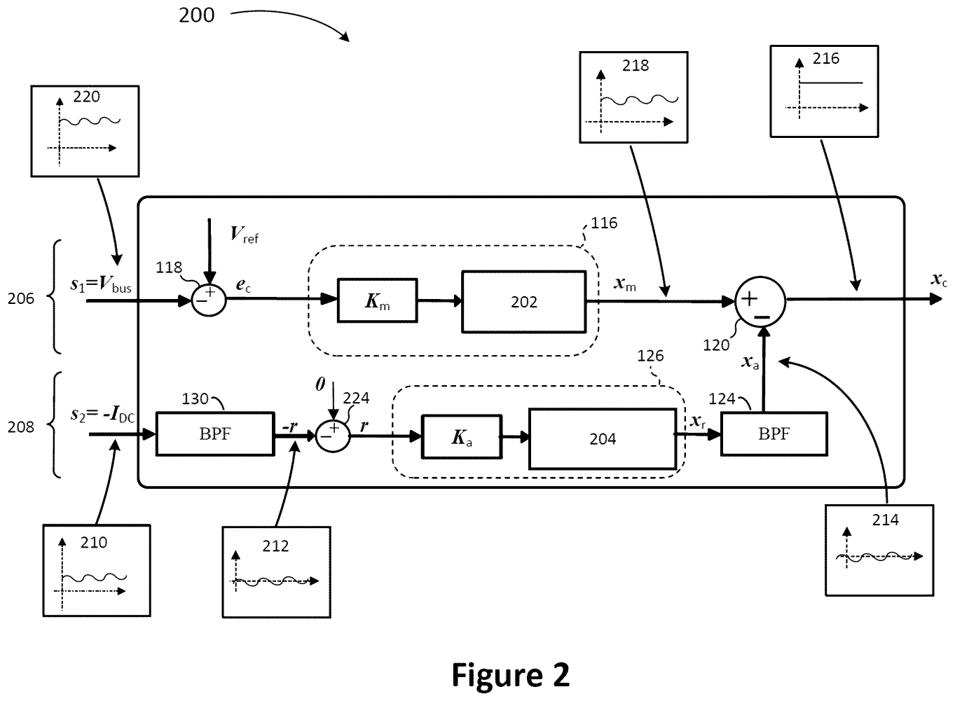

FIG. 2 illustrates an exemplary controller 200 configured to regulate inverter operation of a two-stage bidirectional AC-DC switching power converter incorporating aspects of the embodiments. The exemplary controller 200 is appropriate for use as the controller 106 described above and with respect to FIG. 1, and is similar to the controller 106 where like references indicate like elements.

As an aid to understanding, graphs 210, 212, 214, 216, 218, and 220 are provide to illustrate various signals within the controller 200. Each graph depicts time along a horizontal axis increasing to the right, and signal magnitude along a vertical axis increasing upwards. The graphs 210, 212, 214, 216, 218, 220 are not intended to provide specific information about a signal, such as specific magnitudes or specific times, but are intended to provide only an understanding of the general character of each signal.

In the following discussion, inverter mode operation of the exemplary controller 200 will be described in conjunction with the two-stage bidirectional AC-DC switching power converter 150 described above and illustrated in FIG. 1. Those skilled in the art will readily recognize that the exemplary controller 200 is not so limited and may be advantageously employed to operate any suitable two-stage bidirectional AC-DC power converter.

The exemplary controller 200 includes a main control loop, indicated by the bracket 206 configured to regulate an output of the DC-DC Converter stage 104, and an auxiliary control loop, indicated by the bracket 208, configured to reduce ripple on the external DC power 112.

When operating as an inverter, the output of the DC-DC converter stage 104 is the DC bus voltage V_{bus}. Using the DC bus voltage V_{bus}, or a signal corresponding to the DC bus voltage V_{bus}, as the first converter signal s₁ allows the main control loop 206 to regulate the DC bus voltage V_{bus} in accordance with a reference signal V_{ref}.

An accurate measure of the ripple on the external DC power 112 may be provided by the external DC current I_{DC}. Using the external DC current I_{DC}, or a signal corresponding to the external DC current I_{DC}, as the second converter signal s₂ allows the auxiliary control loop 208 to reduce the ripple on the external DC power 112.

A ripple component is created on the DC bus voltage V_{bus} by the external AC power 108 resulting in a first converter signal s₁, which corresponds to the DC bus voltage V_{bus}, having a ripple riding on a DC voltage as illustrated in the graph 220. Subtracting 118 the first control signal from the DC reference signal V_{ref} generates a converter error signal e_{c}, and applying the main loop compensation 116 to the converter error signal e_{c} generates a main control signal xₘ having a ripple riding on a DC component as illustrated in the graph 218.

The second converter control signal s₂, which corresponds to the external DC current I_{DC}, includes a ripple component riding on a DC value as illustrated in the graph 210. The auxiliary control loop 208 applies a first band pass filter 130 to the second converter signal s₂ to generate a ripple signal r having no DC component as illustrated by the graph 212.

As an aid to understanding, the auxiliary control loop 208 includes a summing node 224 as is used in feedback control loops. Ripple is undesirable, so the reference signal of the auxiliary control loop is set to zero 0. Subtracting any signal from zero results in an inverted version of the signal, thus the output of the summing node is simply the inverse of the ripple signal r. For consistency in signs, the second converter signal s₂ is shown as an inverse of the external DC current I_{DC}, and the output of the summing node becomes an uninvested ripple signal r.

Applying the auxiliary compensation 126 to the ripple signal r produces a ripple control signal xᵣ. Application of the auxiliary compensation 126 can generate undesired frequency components in the ripple control signal xᵣ. For example, a PI controller can generate DC or other low frequency components that are not present in the PI controller's input signal. A second bandpass filter 124 is applied to the ripple control signal xᵣ to generate an auxiliary control signal xₐ having only a ripple component and no DC component as illustrated in the graph 214.

In certain embodiments, the main compensation 116 includes a main control algorithm 202 and a main gain Kₘ, and the auxiliary compensation 126 includes an auxiliary control algorithm and an auxiliary gain Kₐ. Tuning of the controller 200 may be facilitated by using the same control algorithm, such as a PI control algorithm, for both the main control algorithm 202 and the auxiliary control algorithm 204. When the main control algorithm 202 and the auxiliary control algorithm 204 are the same, the controller 200 may be tuned by adjusting the main gain Kₘ and the auxiliary gain Kₐ.

Subtracting 120 the auxiliary control signal xₐ from the main control signal xₘ produces a converter control signal xᵣ that is essentially ripple free as illustrated in graph 216. Subtracting 120 the auxiliary control signal xₐ from the main control signal xₘ reduces the loop gain of the main control loop 206 only at the ripple frequency fᵣ without impacting the transient or dynamic response of the DC bus voltage V_{bus}.

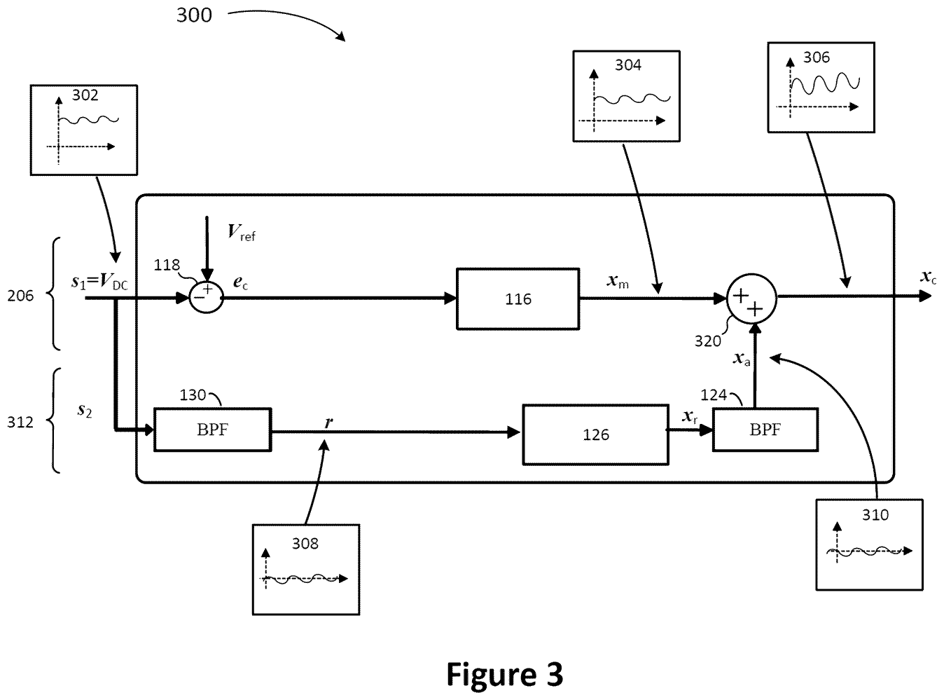

FIG. 3 illustrates an exemplary controller 300 configured to regulate rectifier operation of a two-stage bidirectional AC-DC switching power converter incorporating aspects of the embodiments. The exemplary controller 300 is appropriate for use as the controller 106 described above and with respect to FIG. 1, and is similar to the exemplary controller 200 described above where like references indicate like elements.

As an aid to understanding, graphs 302, 304, 306, 308, and 310 are provide to illustrate various signals within the controller 300. Each graph depicts time along a horizontal axis increasing to the right, and signal magnitude along a vertical axis increasing upwards. The graphs 302, 304, 306, 308, and 310 are not intended to provide any specific information about signals, such as specific magnitudes or times, but are intended to provide only an understanding of the general character of each signal.

In the following discussion, rectifier mode operation of the exemplary controller 300 will be described with respect to the two-stage bidirectional AC-DC switching power converter 150 described above and illustrated in FIG. 1. Those skilled in the art will readily recognize that the exemplary controller 300 is not so limited and may be advantageously employed to operate any suitable two-stage bidirectional AC-DC power converter.

When operating as a rectifier, power flows through the two-stage bidirectional AC-DC switching power converter 150 from the external AC power 108 to the external DC power 112, and the output of the DC-DC converter stage 104 is the external DC voltage V_{DC}. Using the external DC voltage V_{DC}, or a signal corresponding to the external DC voltage V_{DC}, as the first converter signal s₁ allows the main control loop 206 to regulate the external DC voltage V_{DC} in accordance with a reference signal V_{ref}.

The second converter signal s₂ is used to provide ripple information to the auxiliary controller 208. As can be seen in the graph 302, during rectifier operation the external DC voltage V_{DC} includes a ripple voltage riding on a DC component. Using the external DC voltage V_{DC}, or a signal corresponding to the external DC voltage V_{DC}, as the second converter signal s₂ allows the auxiliary control loop 208 to reduce the ripple on the external DC power 112.

The main control loop 208 receives the second converter signal s₂, subtracts is from the reference signal V_{ref} to generate a converter error signal e_{c}. Applying the main compensation 116 to the converter error signal e_{c} produces the main control signal xₘ. Unless an overly large bus capacitor C_{bus} is used, the converter error signal e_{c} will include a ripple component which may not be completely removed from the main control signal xₘ by the main compensation 116 as illustrated in graph 304.

The second converter control signal s₂, which corresponds to the external DC voltage V_{DC}, includes a ripple component riding on a DC value as illustrated in the graph 302.

As described above, the auxiliary control loop 208 applies a first band pass filter 130 to the second converter signal s₂ to generate a ripple signal r having no DC component as illustrated by the graph 308. Applying the auxiliary compensation 126 to the ripple signal r produces a ripple control signal xᵣ. A second bandpass filter 124 is applied to the ripple control signal xᵣ to generate an auxiliary control signal xₐ having only a ripple component and no DC component as illustrated in the graph 310.

Adding 320 the auxiliary control signal xₐ to the main control signal xₘ produces a converter control signal xᵣ with an amplified ripple component as illustrated in graph 306. Adding 320 the auxiliary control signal xₐ to the main control signal xₘ increases the loop gain of the main control loop 206 only at the ripple frequency fᵣ thereby improving suppression of the ripple.

When operating as a rectifier, the bi-directional AC-DC switching converter stage 102 regulates the DC bus power 110 and the external DC voltage V_{DC} is controlled by DC-DC switching converter stage 104 which is regulated by the main control loop 206. In conventional controllers, a PIR-type controller is used to eliminate ripple in the output, however, this type of controller is not valid for inverter operation and therefore adds significant additional complexity when applied in bi-directional converters such as the exemplary two-stage bi-directional AC-DC switching power converter 150.

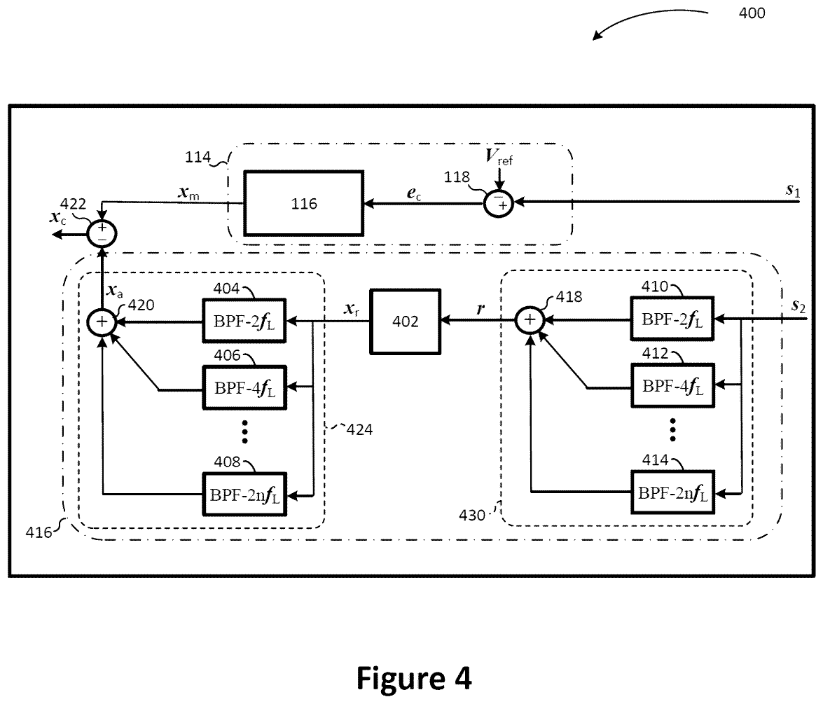

FIG. 4 illustrates an exemplary controller 400 configured to reduce ripple in power converters experiencing nonlinear load behavior incorporating aspects of the embodiments. The exemplary controller 400 is appropriate for controlling a bi-directional AC-DC switching power converter, such as the bi-directional AC-DC switching power converter 150 described above and with respect to FIG. 1. The exemplary controller 400 includes similar elements as the exemplary controller 106 where like references indicate like elements.

When operating as an inverter, the AC output current i_{ac} of a bi-directional AC-DC switching power converter 150 can be non-linear thereby producing non-sinusoidal ripple on the external DC current I_{DC}. To better eliminate the non-sinusoidal ripple, multiple bandpass filters may be included in the auxiliary controller to isolate additional higher harmonics of the ripple to more closely track the non-sinusoidal nature of the ripple induced on the external DC current I_{DC}.

The main control loop 114 remains as described above where a first converter signal s₁, corresponding to the DC bus voltage V_{bus}, is compared with a reference voltage V_{ref} to create a converter error signal e_{c}, and a main compensation 116 is applied to the converter error signal e_{c} to create a main control signal xₘ. Due to the non-sinusoidal nature of the load, a non-sinusoidal ripple may be induced on the external DC current I_{DC} which is being pulled from the external DC power 112.

To improve reduction of the non-sinusoidal ripple induced on the external DC current I_{DC}, the auxiliary controller 416 in the exemplary controller 400 is adapted to generate a non-sinusoidal auxiliary control signal xₐ. The first band pass filter 430 employs a first plurality of bandpass filters 410, 412, . . . 414 to more closely track the non-sinusoidal ripple, where the center frequency of each bandpass filter in the first plurality of bandpass filters 410, 412, . . . 414 is set to a different integer multiple of the ripple frequency fᵣ, 2 fᵣ, . . . nfᵣ. When expressed in terms of the line frequency f_{L}, the center frequency of each bandpass filter in the first plurality of bandpass filters 410, 412, . . . 414 is set to a different integer multiple of twice the line frequency 2 f_{L}, 4 f_{L}, . . . 2nf_{L}.

The output of each bandpass filter in the first plurality of bandpass filters 404, 406, . . . 408 is summed 418 together to form the ripple signal r. Applying the auxiliary compensation 402 to the ripple signal r generates the ripple control signal xᵣ. The auxiliary compensation may be any desired type of control algorithm such as a PI algorithm, PID algorithm, or other suitable control algorithm adapted to reduce ripple in the external DC current I_{DC}.

A second bandpass filter 424 is used to remove undesired frequency components from the ripple control signal xᵣ and generate the auxiliary control signal xₐ. Similar to the first bandpass filter 430, the second bandpass filter 424 includes a second plurality of bandpass filters 404, 406, . . . 408 where the center frequency of each bandpass filter in the second plurality of bandpass filters 404, 406, . . . 408 is a set to a different integer multiple of the ripple frequency fᵣ, 2 fᵣ . . . nfᵣ. The output of each bandpass filter in the second plurality of bandpass filters 404, 406, . . . 408 is summed 420 together to produce the auxiliary control signal xₐ.

The auxiliary control signal xₐ is then subtracted 422 from the main control signal xₘ to produce the converter control signal x_{c}. As described above, subtracting the auxiliary control signal xₐ from the main control signal xₘ reduces the loop gain of the main controller 114 only at the frequencies selected by the first 430 and second 424 plurality of bandpass filters without impacting the transient or dynamic response of the DC bus power 110.

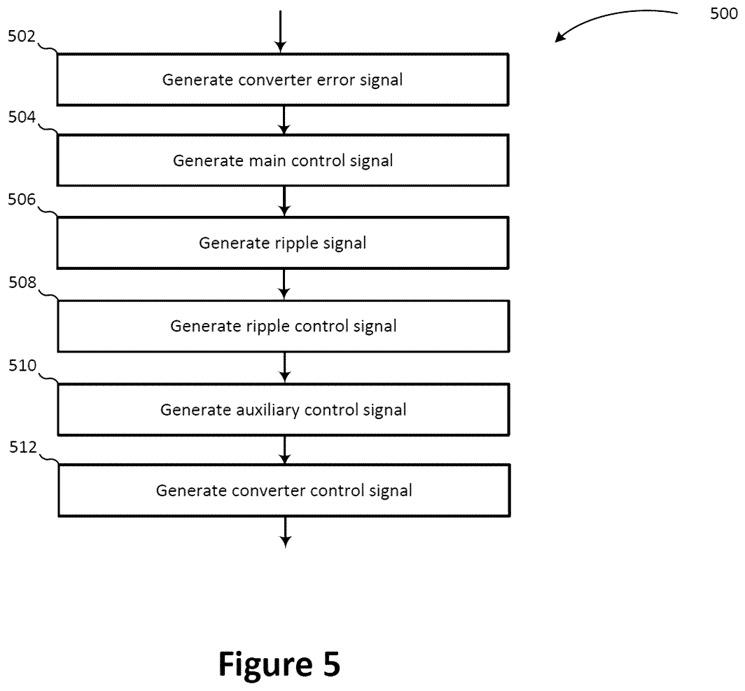

Referring now to FIG. 5, there can be seen a flow chart of an exemplary method 500 for controlling a two-stage bi-directional AC-DC power converter incorporating aspects of the embodiments. The method 500 is appropriate for controlling a two-stage bi-directional AC-DC power converter such as the two-stage bi-directional AC-DC switching power converter 150 described above and with reference to FIG. 1 where the converter includes a bi-directional AC-DC switching converter stage 102 configured to transfer power between an external AC power 108 and a DC bus power 110, and a bi-directional DC-DC switching converter stage 104 configured to receive a converter control signal x_{c} and transfer power between the DC bus power 110 and an external DC power 112. The bi-directional DC-DC switching converter stage 104 is configured to transfer power in accordance with the converter control signal x_{c}.

The method 500 includes generating 502 a converter error signal e_{c} by comparing a first converter signal s₁ with a reference signal V_{ref}. The comparison may be achieved for example by differencing or subtracting the first converter signal s₁ from the reference signal V_{ref}. The first converter signal s₁ corresponds to an output of the bi-directional DC-DC switching converter stage 104 such.

When operating the two-stage bi-directional AC-DC switching power converter 150 as an inverter an appropriate first converter signal s₁ may be a voltage V_{bus} of the DC bus power 110, or a signal corresponding to the voltage V_{bus} of the DC bus power 110. When operating the two-stage bi-directional AC-DC switching power converter 150 as an inverter, an appropriate choice for the first converter signal s₁ may be the voltage of the external DC power 112, or a signal corresponding to the voltage of the external DC power 112.

A main control signal xₘ is generated 504 by applying a main control algorithm to the converter error signal e_{c}. Any suitable control algorithm may be employed as the main control algorithm, such as a PI control algorithm, gain adjusted PI control algorithm, PID control algorithm, or other appropriate control algorithm as desired.

A ripple signal r is generated 506 r by bandpass filtering a second converter signal s₂, where the second converter signal s₂ is selected to provide ripple information suitable for use when removing ripple from the external DC power 112. The second converter signal s₂ may for example be a current I_{DC} of the external DC power 112 when operating the two-stage bi-directional AC-DC switching power converter 150 as an inverter, or a voltage V_{DC} of the external DC power 112 when operating the two-stage bi-directional AC-DC switching power converter 150 as a rectifier.

The bandpass filtering is configured to attenuate frequency components of the second converter signal s₂ that are above or below the ripple frequency fᵣ, where the ripple frequency is twice the line frequency f_{L} of the external AC power 108. Alternatively, the band pass filter may be configured to attenuate frequencies greater than or less than a pre-determined range of frequencies, where the pre-determined range of frequencies is centered about the ripple frequency fᵣ.

A ripple control signal xᵣ is generated 508 by applying an auxiliary control algorithm to the ripple signal r. The auxiliary control algorithm may be any appropriate control algorithm, such as a PI algorithm, a gain adjusted PI algorithm, a PID algorithm, or other suitable control algorithm as desired. In certain embodiments it may be advantageous to employ the same control algorithm as both the main control algorithm and the auxiliary control algorithm. Alternatively, the main control algorithm may be a different control algorithm than used as the auxiliary control algorithm.

An auxiliary control signal xₐ is generated 510 by bandpass filtering the ripple control signal xᵣ to remove any undesirable frequency components which may have been introduced by the auxiliary control algorithm.

A converter control signal x_{c} is generated 512 by combining the main control signal xₘ with the auxiliary control signal xₐ. The converter control signal x_{c} may then be used to regulate the bi-directional DC-DC switching converter stage 104.

When operating as an inverter, generating 512 the converter control signal x_{c} includes subtracting the auxiliary control signal xₐ from the main control signal xₘ, thereby reducing ripple at the external DC power 112 without adversely impacting transient or dynamic response of the DC bus power 110. When operating as a rectifier, generating 512 the converter control signal x_{c} includes adding the auxiliary control signal xₐ to the main control signal xₘ, thereby improving the controller's ability to remove ripple on the external DC power 112.

Thus, while there have been shown, described, and pointed out, fundamental novel features as applied to the embodiments thereof, it will be understood that various omissions, substitutions, and changes in the form and details of devices and methods illustrated, and in their operation, may be made by those skilled in the art without departing from the spirit and scope of the embodiments. Further, it is expressly intended that all combinations of those elements, which perform substantially the same function in substantially the same way to achieve the same results, are within the scope of the embodiments. Moreover, it should be recognized that structures and/or elements shown and/or described in connection with any form or embodiment may be incorporated in any other described or suggested form or embodiment as a general matter of design choice.

What is claimed is:

1. An apparatus (100) comprising:
a bi-directional AC-DC switching converter stage (102) configured to transfer power between an external AC power (108) and a DC bus power (110);
a bi-directional DC-DC switching converter stage (104) configured to receive a converter control signal (x_{c}) and transfer power between the DC bus power (110) and an external DC power (112) in accordance with the converter control signal (x_{c}); and
a controller (106), the controller (106) comprising a main controller (114) and an auxiliary controller (122),
wherein the main controller (114) is configured to:
receive a first converter signal (s₁) and a reference signal (V_{ref});
generate a converter error signal (e_{c}) based on the first converter signal (s₁) and the reference signal (V_{ref}); and
generate a main control signal (xₘ) by applying a main compensation (116) to the converter error signal (e_{c}), and
wherein the auxiliary controller (122) comprises:
a first band pass filter (130) configured to generate a ripple signal (r) based on a second converter signal (s₂);
an auxiliary compensation (126) configured to generate a ripple control signal (xᵣ) by applying the auxiliary compensation (126) to the ripple signal (r); and
a second bandpass filter (124) configured to generate an auxiliary control signal (xₐ) based on the ripple control signal (xᵣ),
wherein the controller (106) is configured to generate the converter control signal (x_{c}) by combining the main control signal (xₘ) and the auxiliary control signal (xₐ).

2. The apparatus (100) according to claim 1 wherein the first converter signal (s₁) and the second converter signal (s₂) comprise one or more of a voltage of the DC bus (V_{bus}), a voltage of the external DC power (V_{DC}), and a current of the external DC power (I_{DC}).

3. The apparatus (100) according to claim 1, wherein the first bandpass filter (130) and the second band pass filter (124) are configured to attenuate frequencies above and below a ripple frequency (fᵣ), wherein the ripple frequency (fᵣ) is two times a line frequency (f_{L}) of the external AC power (108).

4. The apparatus (100) according to claim 1, wherein one or more of the main compensation (116) and the auxiliary compensation (126) comprise a proportional plus integral compensation algorithm.

5. The apparatus (100) according to claim 1, wherein the main compensation (116) and the auxiliary compensation (126) comprise the same control algorithm.

6. The apparatus (100) according to claim 1, wherein
the first bandpass filter (430) comprises a first plurality of band pass filters (410, 412, . . . 414) and the output produced by each bandpass filter in the first plurality of bandpass filters (410, 412, . . . 414) is summed together to produce the ripple signal (r), and wherein a center frequency of each bandpass filter in the first plurality of band pass filters is an integer multiple of two times the line frequency (n*2f_{L}), and
the second bandpass filter (424) comprises a second plurality of band pass filters (404, 406, . . . 408) and the output produced by each bandpass filter in the second plurality of bandpass filters (404, 406, . . . 408) is summed together to produce the auxiliary control signal (xₐ), and wherein a center frequency of each bandpass filter in the second plurality of bandpass filters (404, 406, . . . 408) is the same as the center frequency of a corresponding one bandpass filter in the first plurality of bandpass filters (410, 412, . . . 414).

7. The apparatus (100) according to claim 1, wherein:
the apparatus (100) is operated as an inverter;
the first converter signal (s₁) is the voltage of the DC bus (V_{bus});
the second converter signal (s₂) is the current of the external DC power (I_{DC}); and
the main controller (114) is configured to subtract the auxiliary control signal (xₐ) from the main control signal (xₘ).

8. The apparatus (100) according to claim 1, wherein:
the apparatus (100) is operated as a rectifier;
the first converter signal (s₁) is the voltage of the external DC power (V_{DC});
the second converter signal (s₂) is the voltage of the external DC power (V_{DC}); and
the main controller (114) is configured to add the auxiliary control signal (xₐ) to the main control signal (xₘ).

9. A method (500) for controlling a power converter, wherein the power converter comprises a bi-directional AC-DC switching converter stage (102) configured to transfer power between an external AC power (108) and a DC bus power (110), and a bi-directional DC-DC switching converter stage (104) configured to receive a converter control signal (x_{c}) and transfer power between the DC bus power (110) and an external DC power (112) in accordance with the converter control signal (x_{c}), the method comprising:
generating (502) a converter error signal (e_{c}) by comparing a first converter signal (s₁) with a reference signal (V_{ref});
generating (504) a main control signal (xₘ) by applying a main control algorithm to the converter error signal (e_{c});
generating (506) a ripple signal (r) by bandpass filtering a second converter signal (s₂);
generating (508) a ripple control signal (xᵣ) by applying an auxiliary control algorithm to the ripple signal (r);
generating (510) an auxiliary control signal (xₐ) by bandpass filtering the ripple control signal (xᵣ); and
generating (512) the converter control signal (x_{c}) by combining the main control signal (xₘ) with the auxiliary control signal (xₐ).

10. The method (500) according to claim 9, wherein the first converter signal (s₁) and the second converter signal (s₂) comprise one or more of a voltage of the DC bus (V_{bus}), a voltage of the external DC power (V_{DC}), and a current of the external DC power (I_{DC}).

11. The method (500) according to claim 9, wherein the bandpass filtering comprises attenuating frequencies above and below a ripple frequency (fᵣ), wherein the ripple frequency (fᵣ) is two times a line frequency (f_{L}) of the external AC power (108).

12. The method (500) according to claim 1, wherein the bandpass filtering comprises attenuating frequencies greater than or less than a pre-determined range of frequencies, wherein the pre-determined range of frequencies is centered about the ripple frequency (fᵣ).

13. The method (500) according to claim 1, wherein one or more of the main control algorithm and the auxiliary control algorithm comprise a proportional plus integral control algorithm.

14. The method (500) according to claim 1, wherein the main control algorithm and the auxiliary control algorithm comprise the same control algorithm.
